(19) United States
(12) Patent Application Publication
(10) Pub. No.: US 2026/0229917 A1
(43) Pub. Date: Aug. 6, 2026

(54) METHODS, ARCHITECTURES, APPARATUSES AND SYSTEMS FOR DEDICATED ENERGY HARVESTING

(71) Applicant: InterDigital Patent Holdings, Inc., Wilmington, DE (US)

(72) Inventors: Patrick Cabrol, Bayshore, NY (US); Yifan Li, Conshohocken, PA (US); Guodong Zhang, Woodbury, NY (US); Pascal Adjakple, Great Neck, NY (US); Ravikumar Pragada, Warrington, PA (US)

(21) Appl. No.: 19/149,789

(22) PCT Filed: Jan. 19, 2024
(86) PCT No.: PCT/US2024/012124

§ 371 Date: Jul. 21, 2025

Related U.S. Application Data
(60) Provisional application No. 63/440,168, filed on Jan. 20, 2023.

(51) Int. Cl. H02J 50/00; H02J 50/20; H02J 50/40; H04W 24/08; H04W 24/10; H04W 60/00

(52) U.S. Cl. CPC H02J 50/001; H02J 50/20; H02J 50/40; H04W 24/08; H04W 24/10; H04W 60/00

(57) ABSTRACT

Procedures, methods, architectures, apparatuses, systems, devices, and computer program products for dedicated energy harvesting (DEH). A Wireless Transfer/Receive Unit, WTRU, discovers a first base station of a cell, discovers at least one second base station in the cell, and transmits to the first base station information indicating selection of one of the at least one discovered second base station.

### CROSS-REFERENCE TO RELATED APPLICATION

This application claims the benefit of U.S. Provisional Application No. 63/440,168, filed 20 Jan. 2023, which is incorporated herein by reference in its entirety.

### BACKGROUND

The present disclosure is generally directed to the fields of communications, software and encoding, including, for example, to methods, architectures, apparatuses, systems directed to dedicated energy harvesting (DEH).

### SUMMARY

In a first aspect, the present principles are directed to a method at a Wireless Transfer/Receive Unit, WTRU, comprising receiving, from a first base station in a cell, information indicative of at least one second base station configured for dedicated energy transfer, transmitting to a selected second base station information indicating a request for energy transfer, and performing dedicated energy harvesting from an energy transfer signal received from the second base station.

In a second aspect, the present principles are directed to a Wireless Transfer/Receive Unit, WTRU, comprising memory coupled to at least one processor configured to receive, from a first base station in a cell, information indicative of at least one second base station configured for dedicated energy transfer, transmit to a selected second base station information indicating a request for energy transfer, and perform dedicated energy harvesting from an energy transfer signal received from the second base station.

In a third aspect, the present principles are directed to a method at a Wireless Transfer/Receive Unit, WTRU, comprising receiving, from a base station, information indicative of a configuration for energy harvesting, and harvesting, using the configuration, energy from a signal transmitted by the base station.

In a fourth aspect, the present principles are directed to a Wireless Transfer/Receive Unit, WTRU, comprising memory coupled to at least one processor configured to receive, from a base station, information indicative of a configuration for energy harvesting, and harvest, using the configuration, energy from a signal transmitted by the base station.

In a fifth aspect, the present principles are directed to a method at a first base station, comprising receiving from an energy harvesting device, information indicative of energy harvesting capabilities of the energy harvesting device, transmitting to the energy harvesting device, information indicative of a configuration to use to harvest energy from a dedicated signal transmitted by the first base station, and transmitting the dedicated signal.

In a sixth aspect, the present principles are directed to a first base station, comprising memory coupled to at least one processor configured to receive from an energy harvesting device, information indicative of energy harvesting capabilities of the energy harvesting device, transmit to the energy harvesting device, information indicative of a configuration to use to harvest energy from a dedicated signal transmitted by the first base station, and transmit the dedicated signal.

In a seventh aspect, the present principles are directed to a method at a first base station, comprising receiving, from a second base station located in a cell in which the first base station is located, information indicative of available transmission resources for the first base station, transmitting, to an energy harvesting device located in the cell, information based on the available transmission resources and indicative of future transmission of a signal to use for energy harvesting, and transmitting, to the energy harvesting device, the signal to use for energy harvesting.

In an eighth aspect, the present principles are directed to a first base station, comprising memory coupled to at least one processor configured to receive, from a second base station located in a cell in which the first base station is located, information indicative of available transmission resources for the first base station, transmit, to an energy harvesting device located in the cell, information based on the available transmission resources and indicative of future transmission of a signal to use for energy harvesting, and transmit, to the energy harvesting device, the signal to use for energy harvesting.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates example interaction between a Power Relay Unit (PRU) functional block interaction, a serving gNB and a NZE device within a cell;

FIG. 3 illustrates an example Integrated Access and Backhaul (IAB) network with PRUs;

FIG. 4 illustrates an example of an environment with a PRU associated with a Reconfigurable Intelligent Surface (RIS);

FIG. 5 illustrates the concept of a plurality of PRU nodes within a cell according to an embodiment;

FIG. 6 illustrates a method at a UE for DEH node selection during initial access according to an embodiment;

FIG. 7 is a sequence diagram illustrating a method of NZE device polling from a base station via a PRU;

FIG. 8 is a sequence diagram illustrating a method of a NZE-UE device requesting DEH charge signal from a PRU;

FIG. 9 is a flowchart illustrating a method at a NZE device according to an embodiment; and

FIG. 10 is a flow chart illustrating a polling procedure initiated by a PRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

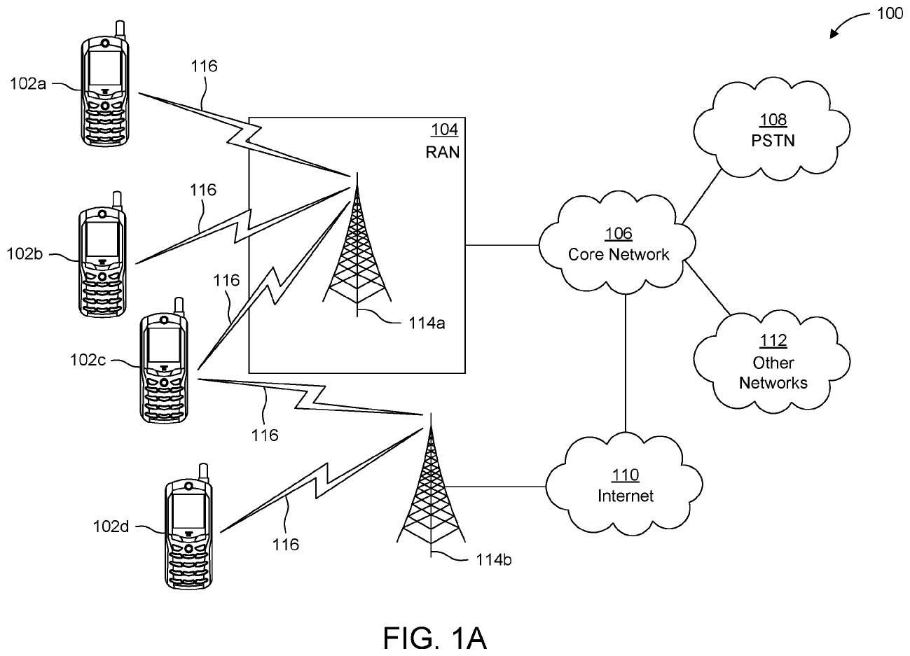

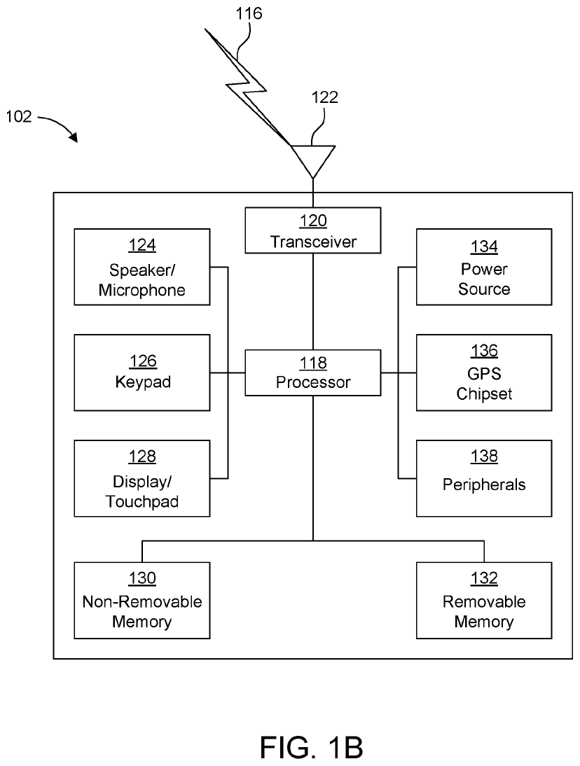

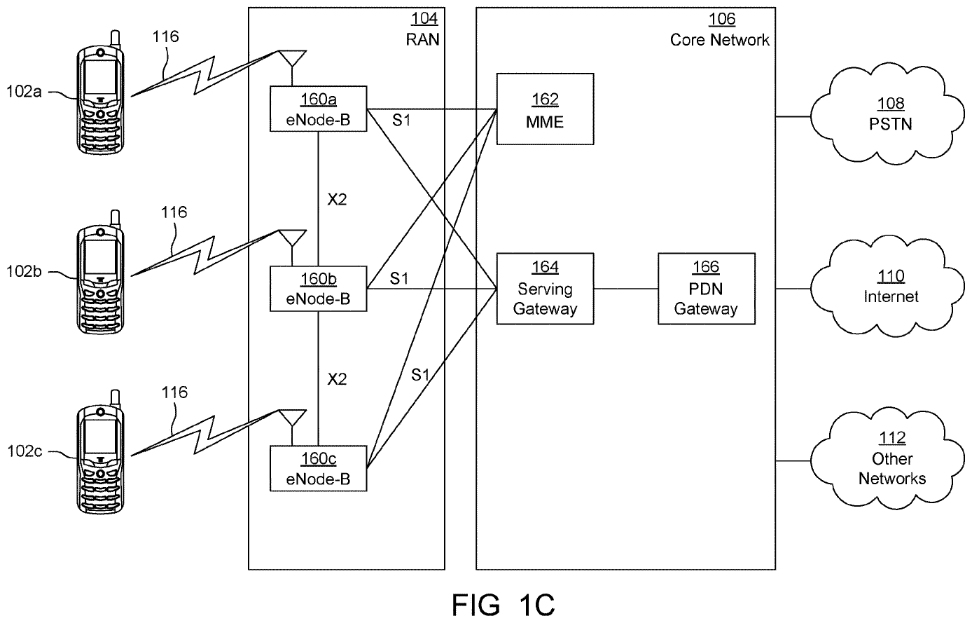

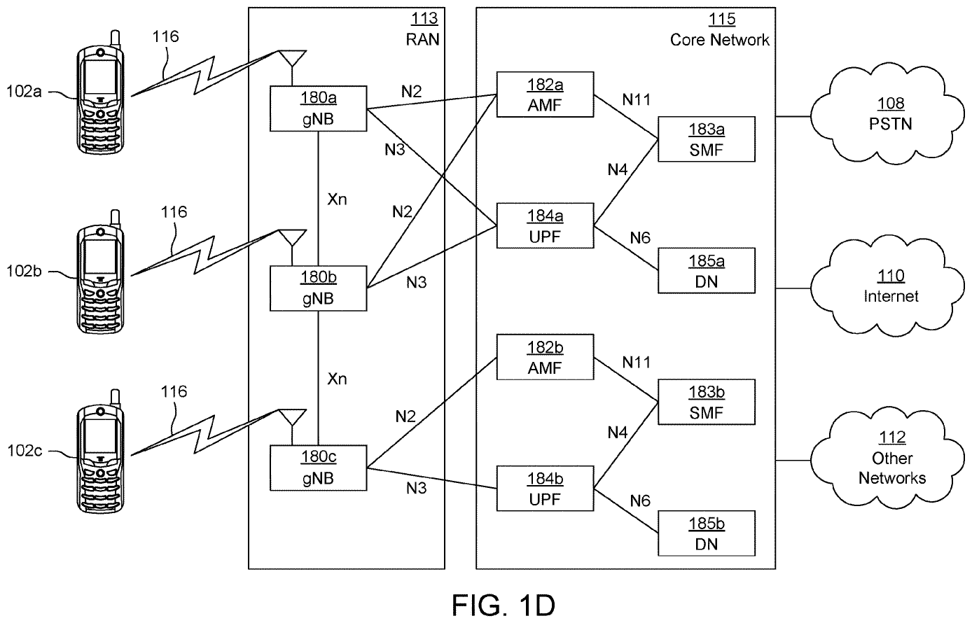

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Advances in Ultra-Low-Power (ULP) RF component design have made it possible to use RF circuitry that can process received RF waveforms collected via an antenna at a receiving device front-end without using an on-board active power supply. Such a device may harvest energy from a transmitted RF power waveform to power, for example, the circuitry necessary for processing other received electrical signals. These passive receivers use RF components such as cascading capacitors, zero-bias Schottky diodes or microelectromechanical systems (MEMS) to implement the functionality required for voltage multipliers or rectifiers, charge pumps and signal detectors. It is noted that passive receivers operate in the antenna far-field and may support fairly large link budgets or distances. In the following, the terms “passive receiver” and “near-zero-energy (NZE) receiver” may be used interchangeably.

To provide wireless power delivery, it is possible to transmit a Dedicated Energy Harvesting (DEH) signal, i.e. a RF signal. A DEH can be transmitted for a period of time to deliver an amount of energy to devices with RF energy harvesting capability. As the separation distance between transmitter and receiver pair increases, a longer power signal transmission period is required to harvest a certain amount of energy, resulting in a significant increase in latency. This can mean that a longer preamble period must precede any data or payload transmission. The use of high gain or directional antennas may partly compensate for the increase in path loss, but comes at the cost of a reduction in the coverage area that may necessitate the use of beam steering techniques.

The energy burden on the receiver circuitry may be reduced by selecting low complexity modulations with lower Signal-to-Noise (SNR) requirements. The cost of this is a reduction in data rate and an increase in susceptibility to interfering signals or a general loss of robustness.

Short or compact message formats reduce the total energy budget needed for data demodulation and processing. In case transmissions of such short messages are followed by a relatively long silence period (e.g. to allow for additional DEH time), this arrangement can reduce the average throughput.

The radio channel presents additional challenges associated with multipaths. Slow and fast fading may affect the received power levels. Furthermore, the RF-to-DC conversion efficiency at the energy harvesting receiver tends to decrease with weaker input signals. Transmit diversity, using multiple units, can help compensate for those variations in path loss. The tradeoff is the added deployment cost of multiple power nodes to achieve higher signal power levels at the harvesting receiver.

In, for example, 5G NR, a typical WTRU spends a significant amount of its energy performing tasks such as control channel monitoring, data transmission and data reception. 5G devices typically consume tens of milliwatts in Radio Resource Control (RRC) idle/inactive state and hundreds of milliwatts in RRC connected state. Energy efficiency is critical for devices not equipped with a continuous source of energy, while sensors deployed for monitoring and measuring, wearables such as smart watches, eHealth and medical monitoring devices can rely on limited capacity battery sources to operate over extended periods of time.

The aforementioned Dedicated Energy Harvesting (DEH) is considered a promising solution to enable Near-Zero Energy mobile communication devices. The total power consumption of an EH device is proportional to the duration of the wake-up periods and the frequency of polling cycles. There is, however, a trade-off between battery life or harvesting time and latency or the ability of the device to quickly respond to wake-up signals.

There is thus a need for ultra-low power mechanism to support low-latency in 3GPP Rel-18, lower than currently specified for Discontinuous Reception DRX/eDRX.

However, dedicated EH has some important performance limitations. As mentioned, energy harvesting circuits tend to present poor sensitivity and low conversion efficiency for incoming low-level power signals. Due to health hazard concerns, maximum allowable RF power radiation limits prevent any significant increase in transmitted wake-up signal (WUS) levels at the base station or gNB. Other losses associated with the physics of the environment and channel conditions include propagation path loss, energy dissipation due to channel fading and shadowing.

Some RF EH efficiency improvement methods are available, such as Multipath Energy Routing (MPER), multi-antenna energy transmission, distributed beamforming techniques and protocol-based optimization for cooperative energy transmission. However, multiple orders of magnitude improvement in harvested energy will not be attained with these techniques.

It will hence be appreciated that, for orders of magnitude increase in harvested power, particularly for devices located at the cell edge, or for latency or time critical operations, new mechanisms are needed to deliver more energy within a given time frame.

### Overview

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A sign, symbol, or mark of forward slash ‘/’ is to be interpreted as ‘and/or’ unless particularly mentioned otherwise, where for example, ‘A/B’ may imply ‘A and/or B’.

The present principles provide a Power Relay Unit (PRU) that can improve the received incident power level at an energy harvesting (EH) receiver unit. A PRU may be a standalone device or a functional block residing in other network infrastructure components. It is intended to be located between a gNB and a NZE device. Generally, its closer proximity to UEs, in comparison to a serving gNB with communication coverage of an entire cell, makes for more efficient transfer of signal energy to NZE devices.

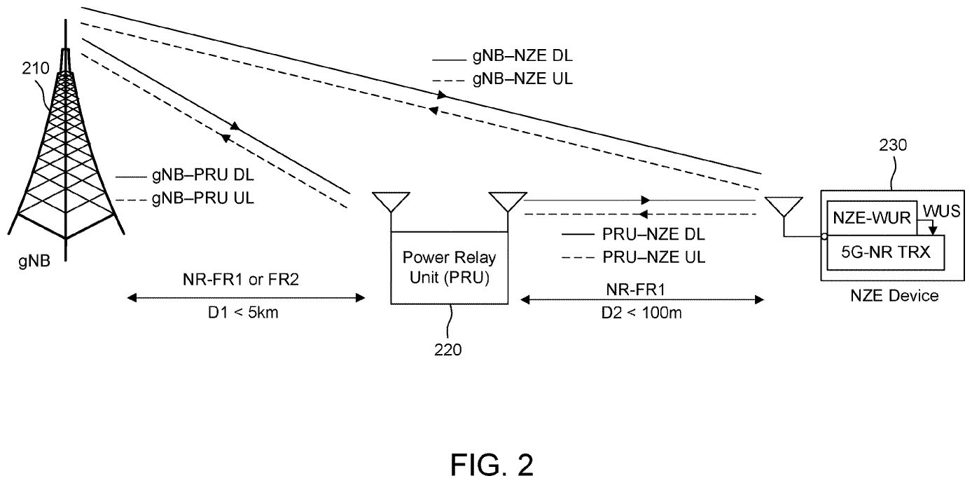

FIG. 2 illustrates example interaction according to the present principles between a Power Relay Unit (PRU) 220 (represented as a functional block), a serving gNB 210 and a NZE device 230 within a cell. In this example, the 5G NR cell can either operate in the FR1 band (below 6 Ghz) or at millimeter wave in the FR2 band. Due to its proximity (D₂) compared to the gNB that can be many kilometers away (D₁), the PRU 220 can deliver orders of magnitude higher power waveforms to the NZE device 230 along with necessary signaling to establish a link with the NZE Wake-Up-Receiver (WUR) device 230 and network information.

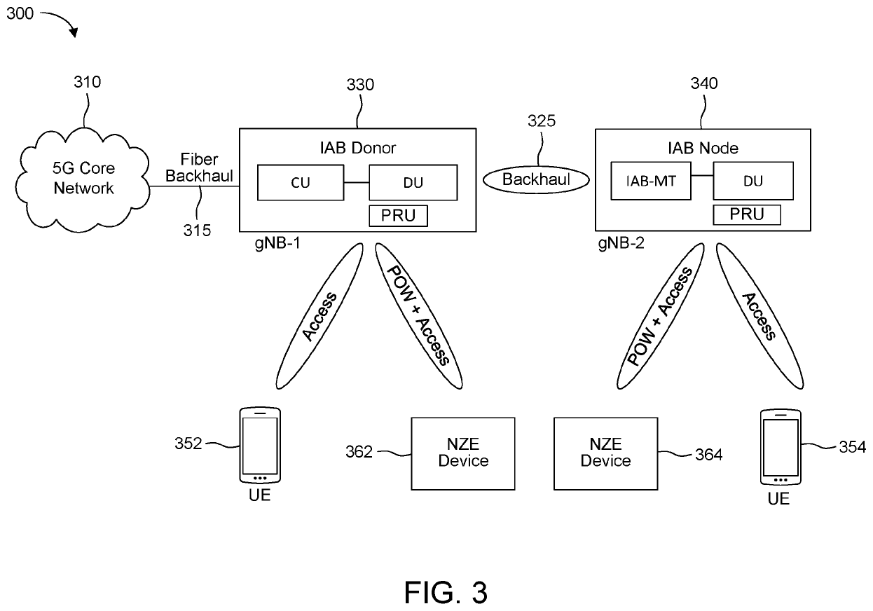

FIG. 3 illustrates an example Integrated Access and Backhaul (IAB) network with PRUS according to the present principles. The IAB network 300 is connected to a 5G core network 310 through a fiber backhaul 315. The IAB network 300 includes an IAB donor 330 and an IAB node 340, connected through a backhaul 325. Each IAB entity (e.g. base station such as a gNB) in the IAB network (i.e. IAB donor and IAB node) can, in addition to conventional equipment allowing UE connectivity, include a PRU. Hence, an IAB entity can provide access to UE 352, 354 and can also, through the PRU, power and communicate with NZE devices 362, 364.

By allowing for multi-hop backhauling, the IAB network 300 can extend the range of PRU nodes within the reach of a NZE device in the cell.

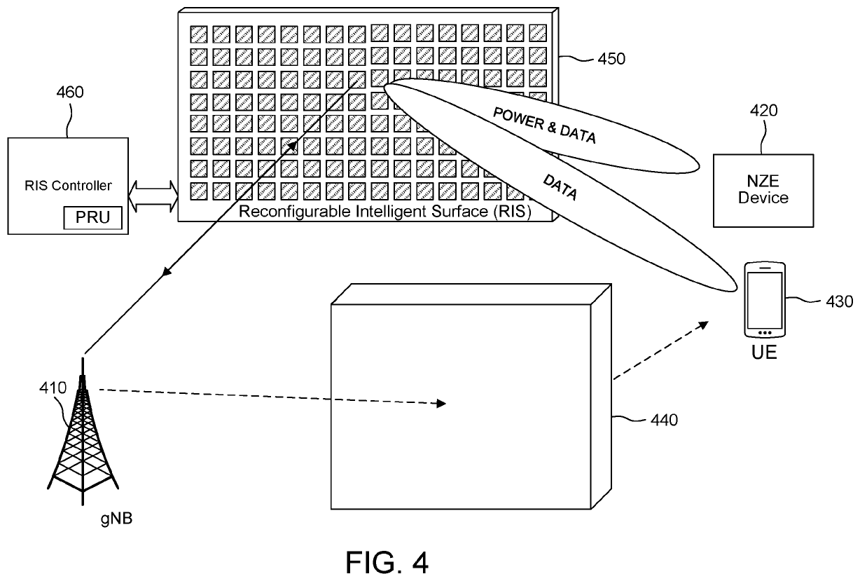

FIG. 4 illustrates an example of an environment with a PRU associated with a Reconfigurable Intelligent Surface (RIS). In the example, direct communication between an base station, gNB, and a NZE device and a UE 430 is blocked or attenuated by an obstacle 440. However, a RIS 450, associated with a RIS controller 460 including a PRU, can control EM wave propagation by changing the E/H fields properties of a reflecting surface. Strategic placement of RIS planar structures render possible the adjustment of radio channel properties in a propagation environment. Improvements in wireless systems' performance, e.g., received signal strength at the NZE device/UE device antenna in the presence of obstacles, are achievable through the use of the RIS, as illustrated in FIG. 4. Backscattering devices requiring harvested energy can also benefit from this arrangement.

A new PRU appearing in a cell can search for and register with the local serving base station (e.g. gNB). The PRU may be a standalone device or part of a device, such as a functional block of an IAB unit or a roadside unit.

The PRU may initiate a discovery procedure that, for example, may use a conventional method. Successful discovery may be followed by a registration process where the PRU can exchange information, for example ID number and location information, with the base station. Capability reporting can also take place to exchange information regarding capability, for example including supported RF bands/frequencies, maximum transmitted power (or WUS max power) and beamforming.

A list of adjacent PRUs located in the same cell or within reach of the new PRU, may be provided by the local base station. This information may be useful to reduce interference between PRU nodes.

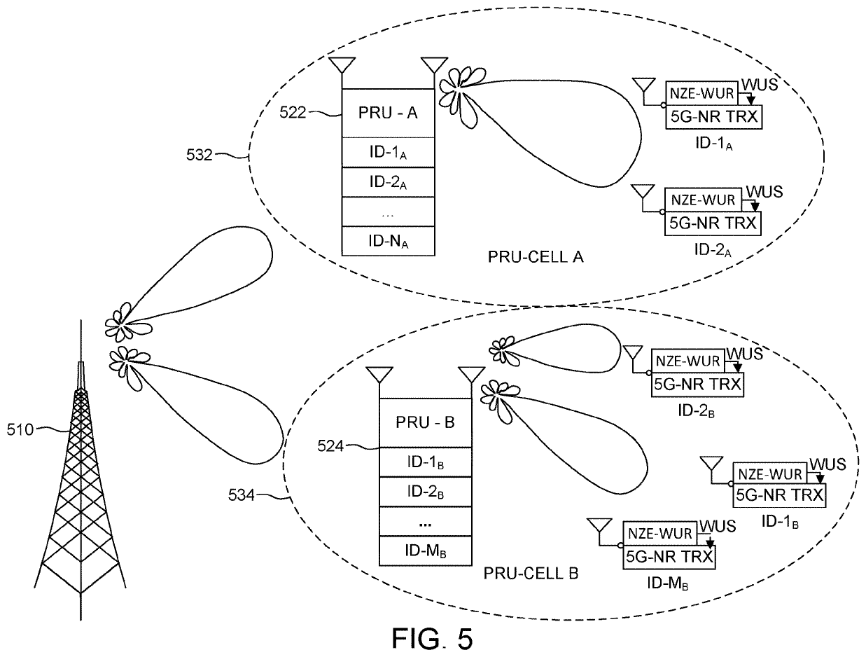

FIG. 5 illustrates the concept of a plurality of PRU nodes within a cell according to an embodiment. Within the serving cell of a base station 510, two PRUs 522, 524 form two separate nodes 532, 534 serving a plurality of NZE devices.

A PRU may also (in addition or instead) initiate discovery and registration to find other PRUs within range. Such discovery may be performed by a new PRU, after receiving a list of local PRU locations and ID numbers from the serving base station control information carried over a control signal.

A UE may be provided with DEH information from the network (e.g., base station, PRU). The DEH information may include configuration parameters for dedicated energy harvesting through broadcast signaling, e.g., in its SIB signals such as SIB N. Similarly, the UE may receive from the network, configuration parameters for DEH through dedicated signaling, for example RRC signaling, MAC CE signaling, PHY signaling or a combination thereof.

The configuration parameters may include configuration parameters of the DEH signal/preambles carrier frequency (e.g. subband, BWP, component carrier), transmission periodicity, preamble format (such as the duration of each DEH preamble, waveform, etc.), time-frequency resources for the transmission of DEH signal/preambles. The configurations of the DEH signal/preamble may be specific to a DEH signal/preamble, or specific to a group of DEH signal/preamble.

The configuration parameters may also (alternatively or in addition) include information regarding a configuration for PRU discovery, for example information about PRU discovery signals and time-frequency resources for the monitoring of the PRU discovery signal.

A PRU may receive from the network (e.g., base station) information including configuration parameters for dedicated energy harvesting. Such information may be received through system information broadcast signaling, dedicated RRC signaling, or combination of dedicated RRC signaling, MAC CE signaling, or PHY DCI signaling.

The PRU configuration for DEH may include configuration parameters of the DEH signal/preambles to transmit toward UEs in support of energy harvesting, such as for example one or more carrier frequency (e.g., subband, BWP, component carrier), transmission periodicity, preamble format (such as the duration of each DEH preamble, waveform, etc.), time-frequency resources for the transmission of DEH signal/preambles, minimum or maximum transmit power, required minimum or maximum received power from UEs served for DEH. The configurations of DEH signal/preamble may be specific to a DEH signal/preamble, or specific to a group of DEH signal/preamble, or UE specific, or a combination thereof.

The PRU configuration for DEH may also (alternatively or in addition) include information including configuration parameters for PRU discovery. Such configuration parameters may include PRU discovery signals and time-frequency resources for the monitoring of the PRU discovery signal.

A UE may trigger the network for DEH configuration by signaling to the network its DEH capability, or by transmitting an explicit DEH configuration request. DEH capability information may include supported DEH frequency information (e.g., subband, BWP, component carrier), supported DEH signal/preamble information e.g., preamble duration, supported waveform(s), support for PRU, etc.

The UE can report its DEH capabilities to the base station during RRC connection or via other signaling. A UE's DEH capability information may include one or more of: band, modulation, data rate, required EH level and preamble duration, UE's location, QCL information, preferred beam, and estimated path loss.

Similarly, a PRU may trigger the network for DEH configuration by signaling to the network its DEH capability, or by transmitting an explicit DEH configuration request. DEH capability information may include supported DEH frequency information (e.g., subband, BWP, component carrier), DEH signal/preamble information, waveform, support for PRU, discovery capability such as supported discovery frequency, supported time-frequency discovery resources, etc.

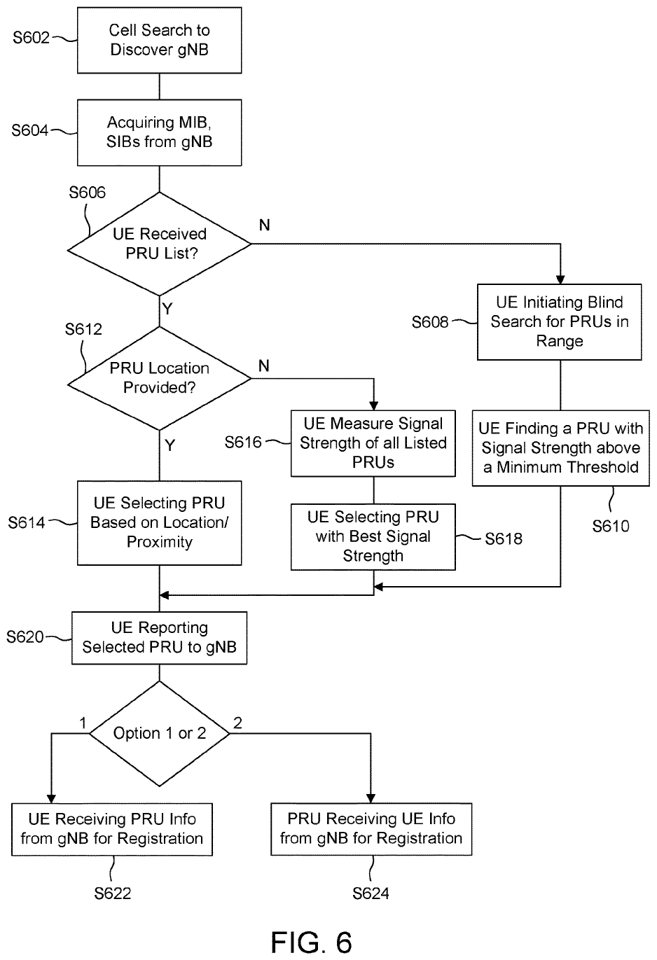

FIG. 6 illustrates a method at a UE for DEH node selection during initial access according to an embodiment.

Generally speaking, the method 600 includes three phases. In a first phase, the UE acquires DEH configuration information, in a second phase, the UE searches for PRU(s) and registers with one of more of them, and in a third phase, a local ID number is assigned to the UE (as illustrated in FIG. 5). The NZE device energy harvesting need, a beam number associated with its current location within the node and other supported features, are associated with this ID.

In step S602, the UE performs a cell search (SSB/PBCH acquisition) to discover a base station (e.g. gNB).

In step S604, the UE acquires information (e.g. Master Information Block, MIB, and System Information Block, SIBs) to obtain DEH configuration information, as already described.

In one example, the UE may receive a list of the local PRU(s) from the base station, e.g., through the SIB N carrying fundamental information for dedicated energy harvesting.

In step S606, the UE determines whether it has received the list of local PRU(s).

In case the UE has not received the list of local PRU(s), in step S608, it initiates a blind search for PRUs in range.

In step S610, the UE may find at least one PRU with a signal strength above a minimum threshold. The UE may select a number of these PRUs (e.g. one, a subset, or all).

In step S620, the UE may report the selected PRU(s) to the base station.

In case the UE has received the list of local PRU(s), in step S612, it determines whether the location of the PRU(s) is provided.

In case the PRU location is provided, in step S614, the UE can select a preferred local PRU (or a plurality of PRUs). For example, the UE can determine the preferred PRU based on the PRU location information and the location of the UE. The UE can then, in step S620, report the selected PRU(s) to the base station.

In case the UE has not received the location of local PRU(s), in step S616, it can measure the signaling strength of the PRUs in the list and, in step S618, select the one(s) with the highest signal strength. The UE can then, in step S620, report the selected PRU(s) to the base station.

The base station can forward information about selected PRU(s) to the PRU (e.g. selected PRUs or all PRUs in the cell) for registration of the new UE.

When several preferred PRUs are reported to the base station, the base station can (option 1) indicate, in step S622, which PRU that the UE should register with to the PRU. Then the UE can send the registration signaling to the indicated PRU and get registered with it. Alternatively (option 2), the base station can, in step S624, forward the new registered UE information to the PRU to complete the registration.

In an embodiment, once the UE selects a PRU, the UE can directly send a registration signaling to this PRU and register with it. The PRU can further forward the new registered UE information to the gNB.

In an embodiment, in step S620, the UE can report the selected PRU along with the signal strength measurement for at least the selected PRU. The base station can assume the reported PRU(s) is the PRU(s) with which the UE is registered, and the base station can further indicate to the PRU(s) that a new UE is registered with the PRU.

In an embodiment, the base station can make the decision with which PRU the UE should register and inform the UE accordingly. Then the UE can send the registration signaling to the indicated PRU for registration. The base station can forward the new registered UE information to the PRU to finish the registration.

In an embodiment, the UE can report its location to the base station and let the base station decide with which PRU this UE should connect. The base station can indicate the PRU information to the UE and indicate the UE information to the associated PRU. The UE can further send registration signaling to the indicated PRU for registration.

In phase 3, once a UE is registered with a PRU, a new ID can be generated for this UE by the base station or by the PRU, which can be further exchanged between them from the generating node to the other node.

The ID can be an ID assigned to each NZE device within a PRU Node. Since the primary method for the PRU to contact a UE, in idle-inactive mode, is to transmit a WUS (including a preamble carrying energy for harvesting), it will typically need to know which beam to use and other resources (DEH/preamble signal duration based on distance and amount of energy needed before wake-up) allocated for that UE, and this information can be associated with the ID. This arrangement can, for example, allow, when a NZE device transits to another node, to use this (potentially portable) ID to transfer the associated NZE device information from the current PRU to the new PRU.

DEH signals or waveforms may be generated at the PRUs using control, data, existing and/or dedicated signaling to provide a certain level of energy harvesting for NZE devices. The DEH signaling may be transmitted according to a specific schedule and generated according to one or a combination of resources. The frequency resources used for transmitting the DEH signaling may be indicated by the base station or the PRU through the cell-specific signaling, e.g., SIB or other broadcast signaling, or through UE specific signaling, e.g., UE specific RRC configuration, MAC Control Element (MAC-CE), Downlink Control Information (DCI), etc.

The amount of energy E_h a DEH capable device may harvest is given by the relationship

$$E\_h \approx ηβα \times B \times P\_rx \times T \qquad ( 1 )$$

where η is the device energy harvesting efficiency, β is the fractional bandwidth allocated by the base station for DEH, and α is the fraction of time with an active energy transfer taking place, B is the device EH bandwidth, P_rx represents the received average power density at the device and T is the total harvesting time.

Resource selection may be based on the allocated combination of parameters from equation (1). It may also depend on resources already allocated or in use by base station/PRU.

A PRU may reserve one or multiple resources for energy transfer where the number of resources may depend on the NZE device capabilities.

Also, a frequency pattern may be predefined in standards and a UE can be configured with the index of a predefined pattern for determining the frequency and bandwidth resources.

The DEH signaling may be periodically transmitted by the PRU in broadcast manner so that UEs in its proximity (or DEH coverage range) may use it, for example for charging their own batteries. DEH signaling may be transmitted in a UE-specific manner, e.g., targeted for one UE. The time pattern of the DEH signaling may be indicated by the base station or the PRU through the cell-specific signaling, e.g., SIB or other broadcast signaling, or through the UE specific signaling, e.g., UE specific RRC configuration, MAC-CE, DCI, etc.

DEH signaling may also be transmitted on demand. The transmission of DEH signaling may be triggered by a request sent by a UE. Such a request may be an explicit DEH signaling transmission request sent by the UE to ask the PRU for transmission. The transmission may be triggered by the low energy status reported by the UE or when the base station or PRU needs to communicate with the UE. For example, when a polling decision is made by the PRU or base station, the PRU/base station may send the DEH signaling to the UE first, e.g., in broadcast manner or in a UE-specific manner, to allow energy harvest before the subsequent procedures.

The DEH signaling may be scheduled to transfer an amount of energy within a certain time. The DEH signaling transmission schedule may help limit interference to other devices and manage the overall network power consumption. The base station along with the PRUs may be responsible for schedule updates to accommodate changes in cell traffic.

Polling may be initiated by the base station/PRU. The base station/PRU may transmit the DEH polling signal in broadcast, groupcast or unicast mode to UE(s). The polling signal may be transmitted in a periodic or aperiodic manner. In the aperiodic mode, DEH polling signals may be transmitted or repeated K times. Upon receiving a DEH poll (or DEH polling signal) from a base station or PRU, the NZE UE may respond to the sending node with a poll response message or signal. Such a poll response can include one or more of a quantized report of energy status at the NZE device; a one-bit indication that the NZE device needs dedicated energy harvesting from the base station/PRU; and detailed information of requested dedicated energy harvesting from the base station/PRU, which may include modulation, data rate, required EH level and preamble duration, UE location, QCL information, preferred beam, estimated pathloss, etc.

The UE may transmit its response to DEH polling signal directly to the base station. Or the UE may respond to the base station polling message to the PRU and the PRU further forward such information to the base station, for example when the device is not able to respond directly to the base station due to low-battery conditions or transmitting capabilities (e.g., weak backscattering for pow-power IoT devices), or when the UE want to save more power by responding to the PRU, etc.

Downlink control signaling or MAC-CE may be used as DEH polling signal to trigger DEH poll response at the NZE device. The downlink control signaling or MAC-CE signal may include a poll field set to an active state indicating that a DEH poll is requested from the NZE device. Additionally, a poll re-transmission bit or state may indicate a request for re-transmission of the polled information based on a re-transmission timer.

The existing DCI format (e.g. as defined in 3GPP Rel.-18) may be reused to carry a DEH poll to the UE. New fields may be added to carry the abovementioned information, e.g., a poll field and/or a poll re-transmission field. One or more existing unused fields may be repurposed and may be used to carry such information. A new DCI format may be defined for the purpose of polling a UE and the new DCI format may carry this information.

Besides the DCI and the MAC-CE, the DEH poll response at the NZE device may be triggered by a reference signal, by a preamble or by some predefined sequences. For example, a low-power wake-up signal (LP-WUS) may be used for this purpose. The UE may transmit its DEH poll response to the base station or the PRU through pre-configured resources, e.g., pre-configured periodic resources. Or the UE may transmit its DEH poll response using resources indicated by the base station or PRU, e.g., through the LP-WUS, etc.

Upon satisfactory reception of the poll response from the NZE-UE(s), the transmitting PRU or base station may stop the transmission of groupcast/Unicast DEH poll signals (periodic and/or aperiodic), and/or reset both the poll request and poll re-transmission fields to “not requesting”.

DEH capabilities may require the usage of control signaling between the UE and the base station/PRU. The NZE UE device may need to send messages to the base station or PRU, such as for example signaling with information listing supported DEH capabilities such as RF bands, bandwidth, waveforms, etc., signaling with information reporting the current DEH charge status, a request for an amount of energy to be delivered within a time duration.

Similarly, the base station/PRU may need to convey messages to the NZE device, such as for example signaling approving or rejecting a DEH transfer request, signaling approving a DEH request with updated harvesting parameters, i.e., amount of energy or duration of transmission, frequencies and bandwidth, and signaling relaying DEH transfer schedule and transmission windows.

In an embodiment, the PRU sends a DEH polling signal to a NZE device and waits for a response, where the DEH polling signal consists of a power waveform and an optional data field. The duration of the power waveform may be proportional to the separation distance or pathloss between PRU and NZE UE device. The duration of the power waveform may also depend on the power status of the NZE device. The power waveform may be a simple CW tone, or a power optimize waveform (POW) with high peak to average ratio.

The PRU may receive a response from the NZE device within a predetermined time window. The response may come from the NZE device main TRX or, in the case of an NZE IoT device, e.g., the response may come from backscattering, if supported.

If a response is not received within the desired time window, the PRU may optionally re-transmit the polling signal with the same power waveform preamble or a preamble of longer duration or a waveform preamble with higher power, to account for potential fluctuations in pathloss, for example.

The PRU may relay a message from the base station to the ULP-UE or NZE-UE device, or the base station may directly send the message to the ULP/NZE device. The UE device may respond directly to the base station on an assigned channel and time slot or RBs, or indirectly to base station via a PRU (e.g., low-power IoT devices).

Upon receiving the UE's response to DEH polling signal, the base station/PRU will start the DEH signal transmission to provide EH to the NZE UE. Such a transmission may have a dynamically allocated duration for each DEH session, which will signaled to the NZE UE via control signaling from base station/PRU. Or each DEH transmission has a fixed or semi-statically configured duration.

The NZE-UE device may monitor its charge or energy level during communication with the base station. If needed, the UE may request additional power signal from the PRU (e.g., low-power IoT device applications).

The base station/PRU may send an end-of-transmission signal to the NZE UE indicating end-of-power waveform transmission to UE device. The transmission may also be stopped once the scheduled transmission is correctly received or when no further DEH signaling request is sent by the UE to the PRU, or when the UE sends an indication that no DEH signaling is needed, e.g., due to the UE being fully charged or when the UE moves to another PRU.

In an embodiment, a timer may be triggered when a DEH signaling transmission is initiated by the PRU or the base station. The timer may be reset whenever a DEH signaling request is received from the UE or when a transmission is needed for the UE at the PRU. Once the timer has expired, the PRU may stop the DEH signaling transmission. The duration of the timer may be configured by the base station/PRU or be determined based on the DEH capabilities reported by the NZE-UE.

The PRU may monitor the activity level within its node by measuring the noise level or the SNR level in the node or in its current direction of transmission (i.e. in the current beam direction). If the measured noise or SNR exceeds a predetermined level, the PRU may dynamically decrease its DEH transmitted signal level to reduce interference in the node or in the current direction of transmission. The PRU may also receive from the base station a request to dynamically reduce its transmitted power level due to a change/increase in data traffic within its node. Alternatively, if the data traffic level, as measured by a change in noise or SNR level in the RF band, falls below a predetermined level for a preset duration, the PRU may increase the DEH signal power level or revert to its original/initial setting.

The NZE-UE may receive an updated energy harvesting schedule from the PRU upon an adjustment or upcoming adjustment in the transmitted DEH power level. The NZE-UE may be required to harvest energy for a longer period to compensate for the reduction in received DEH power.

The base station may, aperiodically or periodically, request transmission of a test DEH signal from the PRU to measure its potential impact in the current cell or in a particular direction. Alternatively, the PRU may request a measurement of its own contribution to noise or interference in the cell to determine its maximum allowable transmit signal power within the current node or in a particular direction.

In an embodiment, the NZE UE may periodically measure its battery voltage level and determine that it has fallen below a predetermined threshold. The NZE UE may also determine that its current battery charge level may not completely support upcoming communications.

Then, the NZE may report its current battery charge level or the amount of power or energy needed, and may request delivery of DEH power from the serving base station or PRU using its main TRX or, for example, in the case of an NZE IoT device, the response may come from backscattering.

The NZE device may then receive a schedule and time/frequency resource blocks for an upcoming delivery of DEH signal. Then, the NZE-UE may configure its power receiver to collect RF energy from the serving PRU/base station.

The NZE device may receive DEH consisting of a power waveform. The duration of the power waveform may be proportional to the separation distance or path loss between PRU and NZE-UE device. The power waveform may consist of a simple CW tone, or a power optimize waveform (POW) with high peak to average ratio.

The NZE device may periodically monitor its battery charge level and report it to the PRU/base station when a predetermined charge or voltage threshold has been reached or exceeded.

The NZE may receive a DCI or MAC CE or higher layer signaling from the PRU/base station which indicates that the resources (time, frequency, and beam) allocated to this EH procedure have been released or are no longer available for DEH.

The periodic DEH preamble transmitted by the base station and PRU(s) may also be regarded as a polling signal. Upon detection of a DEH preamble, the UE may respond. The polling period may be adapted according to response or activity levels.

An aperiodic DEH may be triggered when the UE reports low energy, as indicated.

The polling procedure may be initiated by NZE device. The NZE-UE device may send a DEH request signal/message using its main TRX to a base station or a PRU. The DEH signal/message may include one or more of NZE-UE ID, current battery charge status, updated (GPS) location, current beam number/direction, min/max amount of charge requested and path loss estimate based on received signal strength coming from base station/PRU.

NZE-UE(s) may also use backscattering-based communications to provide feedback to the serving base station/PRU. Backscattering techniques are generally suitable for feedback only and may be unsuited to initiate control signaling from the NZE-UE, except for ambient backscattering scenarios.

Energy transfer requests may be initiated using a poll message generated from the base station/PRU with broadcast/multicast/unicast backscattering configuration followed by a carrier transmission.

The NZE-UE may derive the timing to modulate a backscattering signal transmitted from the serving base station/PRU based on the reception of NZE control messages from the serving base station/PRU. The timing may for example be based on one or more of reception of NZE signaling based on a schedule configured over an NZE or main interface, the NZE-UE device ID, a request for a response and a timing delay in the NZE control message. The timing delay may be used to make a relative comparison to a reference marking. A NZE control message may include an end-of-message symbol or code to indicate, to the NZE, reception of a complete NZE control message.

It may be preferred that the base station/PRU guarantees that the backscattering feedback operation does not interfere with the regular downlink transmissions scheduled by the network for legacy information UEs. This may be possible through frequency and time resource allocation optimization with sufficient guard bands between frequency resources allocated for backscattering operation and regular downlink transmissions.

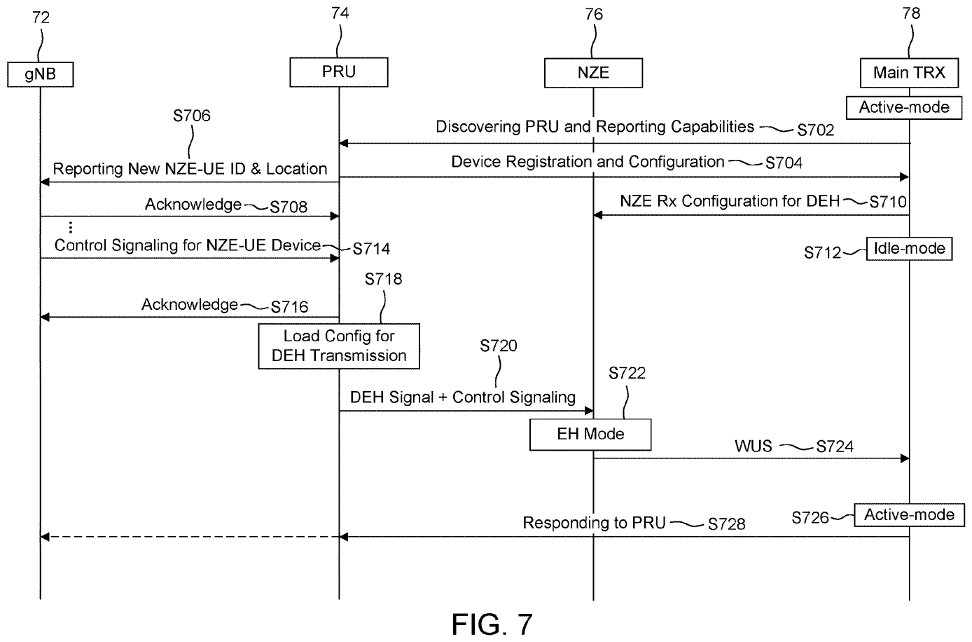

FIG. 7 is a sequence diagram illustrating a method of NZE device polling from a base station via a PRU.

Starting in active mode, in step S702, the main TRX 78 discovers a PRU and reports its harvesting and other capabilities and receive configuration information. In step S704, the main TRX 78 registers the NZE 76 with the PRU 74 (and, conversely, the PRU 74 registers the NZE 76).

In step S706, the PRU 74 may transmit a message to report the presence of a new NZE-UE to the serving base station (gNB) 72 that, in step S708, transmits an acknowledgement.

In step S710, the main TRX 78 may provide the receive configuration parameters to the NZE device 76 and, in step S712, may enter idle mode.

The base station 72 may, in step S714, forward control signaling intended for the NZE-UE to the local PRU when the base station wants to poll a NZE-UE. The base station may receive an acknowledgement from the PRU in step S716. In step S718, The PRU may load the configuration settings and, in step S720, transmit a DEH signal to the intended NZE-UE unit. Upon receiving the dedicated energy signal, the NZE receiver 76 may, in step S722, harvest energy to trigger its main TRX 78 and, in step S724, instruct it (e.g. by sending a WUS) to respond directly to the serving gNB or via the local PRU. In step S726, the main TRX 78 goes to active mode and, in step S728 transmits a response to the PRU 74 or the base station 72, for example to notify the PRU 74 of the battery charge of the NZE.

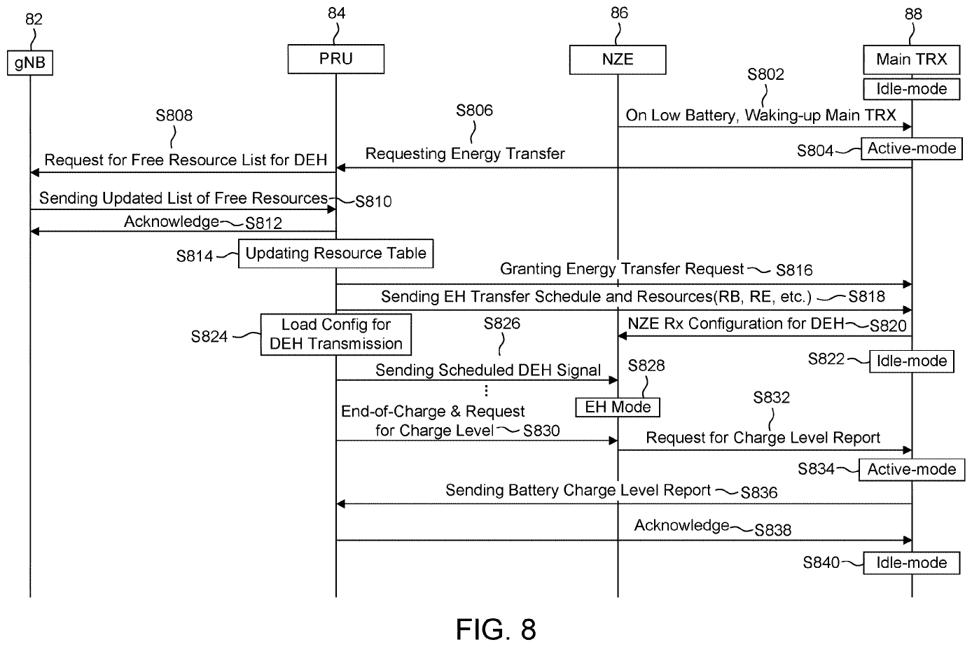

FIG. 8 is a sequence diagram illustrating a method of a NZE-UE device requesting DEH charge signal from a PRU.

As the battery charge level of a NZE 86 falls below a minimum threshold, it may, in step S802, trigger or wake-up its main TRX 88 from idle state. In step S804, the TRX 88 may go to active mode and, in step S806, request energy transfer from its PRU 84.

In step S808, the PRU 84 may request an (updated) list of available resources from the base station 82 with the intention of minimizing interference in the cell. In step S810, the base station 82 may transmit the list to the PRU 84 that, in step S812, may send an acknowledgement to the base station 82 and, in step S814, update its resource table.

In step S816, the PRU 84 may transmit to the main TRX 88 a grant for the energy transfer request and, in step S818, transmit a schedule and available resources.

In step S820, the main TRX 88 may transfer configuration settings (or directly configure) the NZE receiver 86 with the provided settings and, in step S822, go to idle mode.

In step S824, the PRU 84 prepares for DEH transmission by loading its configuration and, in step S826, sends a scheduled DEH signal. In step S828, the NZE 86 harvests energy from the received DEH signal.

In step S830, the PRU 84 may transmit to the NZE 86 a request for battery or charge level status. Upon reception of this request, in step S832, the NZE 86 may transmit to the main TRX 88 a request to transmit a battery status.

In step S834, the main TRX 88 may go to active mode and, in step S836, transmit a message including information indicating the battery of charge level status to the PRU 84. Then, the UE's main TRX 88 may, in step S840, return to idle mode after receiving, in step S838, an “acknowledge” message from the PRU or after a timer has expired.

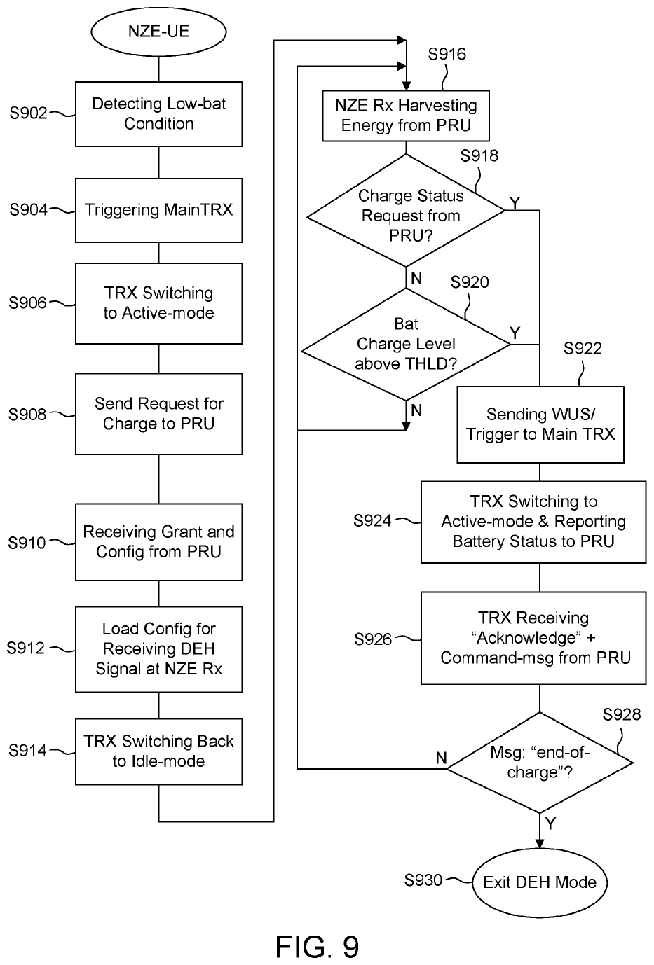

FIG. 9 is a flowchart illustrating a method at a NZE device according to an embodiment in which the NZE device requests and receives a polling signal via a PRU. In the description of FIG. 9, the NZE device is assumed to include the main TRX.

In step S902, the NZE device detects a low battery condition and, in step S904, triggers the main TRX to switch to active mode. In step S906, the main TRX switches to active mode and, in step S908, sends a request for energy (charge, DEH) to a PRU. In step S910, the main TRX receives from the PRU a grant confirmation and receiver configuration settings to receive a DEH signal. In step S912, the NZE prepares for DEH reception by loading the configuration settings and setting them. In step S914, the main TRX may switch back to idle mode while the NZE-UE may prepare to harvest the energy transmitted from the PRU.

In step S916, the NZE Rx receives a DEH from which it harvests energy.

In step S918, the NZE determines if it has received a charge status request from the PRU.

If this is not the case (i.e. no request received), in step S920, the NZE may determine whether the battery charge level is above a threshold value (i.e. if the battery is sufficiently charged). In case the charge level is not above the threshold, the NZE goes back to harvesting energy (in step S916).

In case the NZE has received a charge status request (S918) or in case the battery is sufficiently charged (S920), in step S922, it sends a trigger (e.g. WUS) to the main TRX to go to active mode.

In step S924, the main TRX goes to active mode and transmits a message including information indicating battery charge status to the PRU.

In step S926, the main TRX may receive an acknowledgment from the PRU and may also receive a command message from the PRU.

In step S928, the NZE determines whether the message includes information indicating end of charge by the PRU.

In case the information does not indicate end of charge, the NZE may go back to harvesting energy (in step S916).

In case the information indicates end of charge, in step S930, the NZE may end energy harvesting.

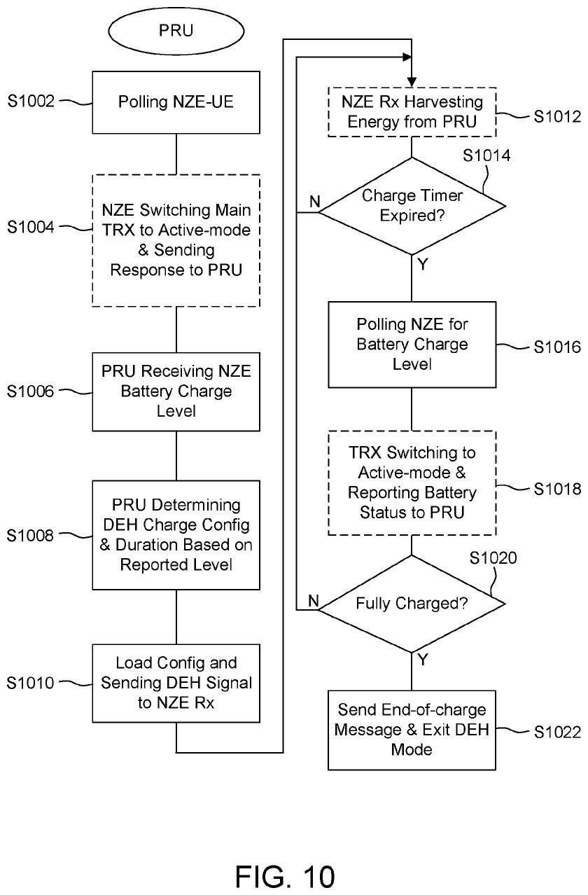

FIG. 10 is a flow chart illustrating a polling procedure initiated by a PRU.

In step S1002, the PRU sends a polling signal to a NZE device requesting a status report of its battery or charge condition. The polling signal may include a preamble or power optimized waveform (POW) followed by a data or payload field.

In step S1004, upon receiving the DEH signal, the NZE UE may trigger its main TRX to active mode to initiate a response to the PRU.

In step S1006, the PRU receives the response including information indicative of the battery charge status. In step S1008, the PRU may determine, based on the information received from the NZE, if a DEH transmission is needed and its configuration and duration. In step S1010, the PRU transmits a DEH signal for a predetermined duration.

In step S1012, the NZE receives the DEH signal and harvests energy from it.

In step S1014, the PRU determines whether a charge timer has expired (i.e. if the duration has passed). In case the timer has not expired, the DEH signal transmission continues.

In case the timer has expired, in step S1016, the PRU may send another polling signal to assess the battery charge progress. In step S1018, the main TRX goes to active mode and reports the battery charge status to the PRU. In step S1020, the PRU may determine whether or not more charge is required by the NZE. If more charge is required, the PRU resumes the DEH transmission (i.e. the method returns to step S1010). However, if more charge is not required, for example if the battery is fully charged, in step S1022, the PRU may transmit an end-of-charge message to the NZE-UE.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

1. A method at a Wireless Transfer/Receive Unit, WTRU, comprising:
receiving, from a first base station in a cell, information indicative of a plurality of second base stations configured for dedicated energy transfer;
measuring respective received signal strengths of signals received from the plurality of second base stations;
transmitting, to the first base station, a report comprising at least two preferred second base stations, the at least two preferred second base stations having highest respective signal strength among the plurality of second base stations;
receiving, from the first base station, an indication of a selected second base station among the at least two preferred second base stations;
transmitting to the selected second base station information indicating a request for energy transfer; and
performing dedicated energy harvesting from an energy transfer signal received from the second base station.

2. The method of claim 1, further comprising, prior to the receiving information indicative of a plurality of second base stations configured for dedicated energy transfer:
transmitting, to the first base station, information indicative of a request for energy transfer.

3. (canceled)

4. The method of claim 1, further comprising, prior to the performing:
receiving, from the first base station, information for registering with the selected second base station; and
registering with the selected second base station.

5.-6. (canceled)

7. A Wireless Transfer/Receive Unit, WTRU, comprising memory coupled to at least one processor configured to:
receive, from a first base station in a cell, information indicative of a plurality of second base stations configured for dedicated energy transfer;
measure respective received signal strengths of signals received from the plurality of second base stations;
transmit, to the first base station, a report comprising at least two preferred second base stations, the at least two preferred second base stations having highest respective signal strength among the plurality of second base stations;
receive, from the first base station, an indication of a selected second base station among the at least two preferred second base stations;
transmit to the selected second base station information indicating a request for energy transfer; and
perform dedicated energy harvesting from an energy transfer signal received from the second base station.

8. The WTRU of claim 7, wherein the at least one processor is further configured to, prior to the receive information indicative of a plurality of second base stations configured for dedicated energy transfer:
transmit, to the first base station, information indicative of a request for energy transfer.

9. (canceled)

10. The WTRU of claim 7, wherein the at least one processor is further configured to, prior to the perform:
receive, from the first base station, information for registering with the selected second base station; and
register with the selected second base station.

11.-52. (canceled)
